(19) United States
(12) Patent Application Publication
(10) Pub. No.: US 2019/0039447 A1
(43) Pub. Date: Feb. 7, 2019

(54) Transmission for a Motor Vehicle, and Composite Consisting of Such a Transmission and a Powertrain Side Shaft

(71) Applicant: ZF Friedrichshafen AG, Friedrichshafen (DE)

(72) Inventors: Peter Ziemer, Tettnang (DE); Peter Tiesler, Meckenbeuren (DE); Andreas Beisswenger, Friedrichshafen (DE); Robert Reiser, Nenzingen (DE)

(21) Appl. No.: 16/075,377

(22) PCT Filed: Jan. 16, 2017
(86) PCT No.: PCT/EP2017/050797

§ 371 Date: Aug. 3, 2018

(30) Foreign Application Priority Data
Feb. 8, 2016 (DE) 10 2016 201 849.3

(51) Int. Cl. B60K 6/48; B60K 6/26; B60K 6/365; B60K 6/405; B60K 6/547; F16H 3/66

(52) U.S. Cl. CPC B60K 6/48; B60K 6/26; B60K 6/365; F16H 2003/442; B60K 6/547; F16H 3/66; B60K 6/405

(57) ABSTRACT

A transmission (G) for a motor vehicle includes an input shaft (GW1), an output shaft (GW2), a differential gear (AG), an interface (IF) to a transmission-external drive unit, an electric machine (EM) with a rotationally fixed stator (S) and a rotary rotor (R), a plurality of planetary gear sets (PS, PV), and a plurality of shift elements (A, B, C, D, E). The electric machine (EM) is arranged at an axial end of the transmission (G) which is positioned opposite the interface (IF) to the transmission-external drive unit. An area (X) directly adjacent to the differential gear (AG) is configured for accommodating a joint (GL) of a motor vehicle side shaft (DS) and is arranged completely or at least in part in an installation space radially outside the electric machine (EM).

### FIELD OF THE INVENTION

The invention relates generally to a transmission for a motor vehicle, and to an assembly including a transmission with a drive train side shaft.

### BACKGROUND

In motor vehicles, in particular, including a drive train aligned transversely to the direction of travel of the motor vehicle, the use of an electric machine for the hybridization of the drive train results in confined installation space conditions. This is the case because the internal combustion engine, including its auxiliary units, the transmission, and the electric machine, usually must be arranged between driving wheels of the motor vehicle. Frequently, at least one of the longitudinal members of the motor vehicle body is bent upward in order to create more installation space for the transmission. In addition, the kinematics of the drive shafts and of the chassis must be taken into account.

Patent application DE 10 2014 204 009 A1 describes a multi-stage planetary transmission system as a component of a motor vehicle drive train, which includes a power input, a power output, two planetary transmission stages, two clutch units, two brake units, and an electric motor. The planetary transmission system allows for the implementation of four forward gears in this case. In FIG. 7c of said patent application, an embodiment is represented, in which the power input and the electric motor are arranged at axially opposite axial ends of the planetary transmission system. The power output is arranged axially between the two clutch units and the two planetary transmission stages, and acts as an interface to a differential.

Patent application US 2006/0169506 A1 describes a hybrid vehicle including a planetary transmission between the internal combustion engine and a generator. The planetary transmission is connected to a differential which is connected to the front driving wheels of the hybrid vehicle via drive shafts. Wheel hub motors for driving the hybrid vehicle are integrated into the driving wheels.

The outer dimensions of a powerful electric machine, such as that utilized in plug-in hybrid vehicles, are substantially larger than those of an electric machine of a mild hybrid vehicle. If the drive train of a plug-in hybrid vehicle is to allow for more than only four forward gears, the integration of the planetary transmission system known in the prior art, in combination with a powerful electric motor, into the front end of a motor vehicle can be difficult.

### SUMMARY OF THE INVENTION

As used herein, a transmission means, in particular, a multi-stage transmission, in which a multitude of gears, i.e., fixed transmission ratios between two shafts of the transmission, are preferably automatically shiftable by shift elements. In this case, the shift elements are clutches or brakes, for example. Such transmissions are utilized primarily in motor vehicles in order to adapt the rotational speed and torque output characteristic of the drive unit to the driving resistances of the vehicle in a suitable way. In motor vehicles having front-transverse drive, the transmission may include a differential gear, via which the output power of the transmission is distributed to driving wheels of the motor vehicle via two side shafts which can be connected to the transmission.

In an example aspect, the invention provides a transmission for a motor vehicle, which is suitable for use in the front end of a motor vehicle and is distinguished by an installation-space-saving design. In another example aspect, the drive train is optimized with regard to the components surrounding the transmission.

The transmission includes an input shaft, an output shaft, a differential gear, an interface to a transmission-external drive unit, an electric machine including a rotary rotor and a rotationally fixed stator, a plurality of planetary gear sets, as well as a plurality of shift elements. The transmission-external drive unit can be an internal combustion engine, for example.

Via the planetary gear sets, various transmission ratios between the input shaft and the output shaft can be implemented by selectively engaging or maintaining the disengagement of the shift elements. Preferably, at least six forward gears can be implemented. In addition to the planetary gear sets, spur gear trains can also be utilized for implementing gears.

The output shaft is permanently operatively connected to at least one of the elements of the planetary gear sets and includes a tooth system at an interface. This tooth system intermeshes with a shaft arranged axially parallel to the output shaft. This axially parallel shaft is permanently operatively connected to an element of the differential gear. This permanent operative connection can be formed, for example, by a direct connection, or can include yet another gear stage.

The rotor of the electric machine is connected to at least one element of the planetary gear sets or to the input shaft in such a way that power transmission is possible between the electric machine and the output shaft at least in selected gears and preferably in all gears. The electric machine is arranged, in this case, at that axial end of the transmission which is positioned opposite the interface to the transmission-external drive unit. The interfaces to the transmission-external drive unit and the electric machine are therefore arranged on opposite axial ends of the transmission. The interface of the output shaft, on which the tooth system is formed, is arranged, in the axial direction, between the interface to the transmission-external drive unit and the electric machine.

According to example aspects of the invention, an area directly adjacent to the differential gear, which is configured for accommodating a joint of a side shaft of the drive train, is arranged completely or at least in part in an installation space radially outside the electric machine. The side shaft is configured for transmitting torque between an element of the differential gear and a driving wheel of the motor vehicle. The joint of the side shaft, together with yet another joint, is configured for enabling the torque transmission between the differential gear and the driving wheel despite their relative movement with respect to each other.

In a front-transverse drive train, the differential gear is usually offset from the center, thereby resulting in different lengths of the side shafts. The shorter of the two side shafts is usually that side shaft, in this case, which points away from the internal combustion engine. The side shaft is to be designed to be as long as possible, in this case, in order to achieve advantageous chassis kinematics and reduce the joint loading. For this purpose, the differential gear is to be arranged as close as possible to the interface between the transmission and the internal combustion engine. This is facilitated by the arrangement of the electric machine at that axial end of the transmission which is positioned opposite the interface to the internal combustion engine. The side shaft, including its joint sealing cups, must not touch the transmission during operation of the vehicle, and therefore sufficient distance must be maintained between the side shaft and the transmission, with consideration for the side shaft kinematics.

Example aspects of the invention are based on the finding that the outer diameter of the differential gear is considerably greater than the outer diameter of the side shaft joint, and the side shaft is usually centrally connected to the differential gear via its inner joint. In the configuration of a front-transverse drive train, an arrangement of the differential gear axially offset with respect to the electric machine is therefore preferred in order to obtain a radially compact design. This also simplifies the bridging of the center distance between the output shaft and the differential gear. The arrangement of the side shaft joint in an area radially outside the electric machine, directly adjacent to the differential gear, allows for the formation of a very small air gap between the side shaft joint and the transmission housing, since the outer diameter of the side shaft joint has no relative movement with respect to the transmission housing, apart from the rotation of the side shaft joint. The outer diameter of the electric machine can therefore be optimized.

Preferably, the area for accommodating the side shaft joint directly abuts the outer wall of a transmission housing section, while forming an air gap. The electric machine is arranged on the inside of this transmission housing section. This housing section can also include a cooling jacket for cooling the electric machine. In other words, the area for accommodating the side shaft joint axially overlaps with the area of the transmission in which the electric machine is arranged.

According to one preferred embodiment, the planetary gear sets are arranged axially between the interface of the output shaft, i.e., the output-shaft tooth system, and that axial end of the transmission at which the electric machine is arranged. Such an arrangement facilitates a compact design of the transmission.

Preferably, at least one of the shift elements is designed as a friction-locking brake, for example, as a lamellar shift element, which is utilized for the rotationally fixed fixing of an element of at least one of the planetary gear sets, and therefore contributes to the gear implementation. This brake is arranged axially between the interface of the output shaft, i.e., the output-shaft tooth system, and the electric machine. In addition, this brake is arranged radially outside the planetary gear sets. These types of multi-disk brakes are preferably to be designed with a large diameter in order to increase their effective frictional surface. Such an arrangement of the brake also facilitates a compact design of the transmission.

Example aspects of the invention also relate to an assembly including a transmission described at the outset and a side shaft connected to the differential gear of the transmission, which is configured for transmitting torque between an element of the differential gear and a driving wheel of the motor vehicle. According to example aspects of the invention, the inner side shaft joint of this side shaft is arranged completely or at least in part radially outside the electric machine of the transmission. Preferably, the side shaft joint directly abuts the outer wall of a transmission housing section, while forming an air gap, and the electric machine of the transmission is arranged on the inside of said outer wall.

### BRIEF DESCRIPTION OF THE DRAWINGS

One exemplary embodiment of the invention is described in detail in the following with reference to the attached figures. Wherein:

FIG. 1 and FIG. 2 show schematic sections of a transmission according to the exemplary embodiment of the invention; and

FIG. 3 shows a cutaway view of one structural exemplary embodiment of the transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

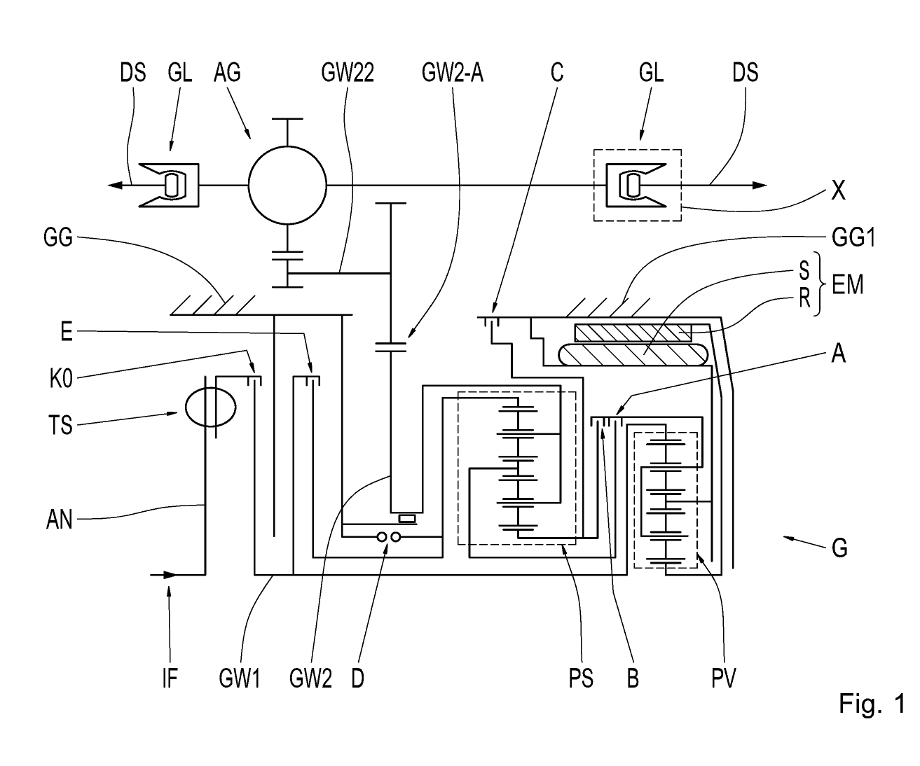

FIG. 1 shows a schematic view of a transmission G according to one exemplary embodiment of the invention. The representation selected in FIG. 1 is to be considered merely as a schematic, and acts as an overview of the basic design of the transmission G. The transmission G includes an input shaft GW1, an output shaft GW2, and planetary gear sets PS, PV, each of which includes two radially nested single planetary gear sets. Furthermore, the transmission G includes a first shift element C, a second shift element A, a third shift element B, a fourth shift element E, and a fifth shift element D. Via the planetary gear set PS and the further planetary gear set PV, various transmission ratios between the input shaft GW1 and the output shaft GW2 can be implemented by selectively engaging the shift elements A, B, C, D, E. The shift element marked as C operates as a brake, and is designed as a friction-locking shift element. By engaging the shift element C, a rotationally fixed connection is established between a sun gear of the planetary gear set PS and a transmission housing GG. The shift element C is arranged radially outside the planetary gear set PS in this case.

The transmission G further includes an electric machine EM which includes a rotationally fixed stator S and a rotary rotor R. The rotor R is permanently connected to a sun gear of the planetary gear set PV. The electric machine EM is designed as a so-called external rotor, whereby the rotor R is arranged radially outside the stator S. The electric machine EM is arranged at that axial end of the transmission G which is positioned opposite an interface IF to a transmission-external drive unit.

The transmission G further includes a connecting shaft AN, a torsional vibration damper TS, and a separating clutch K0. The connecting shaft AN acts as a torque-transmitting connection to the transmission-external drive unit in the area of the interface IF. The connecting shaft AN can be connected to the input shaft GW1 by engaging the separating clutch K0. The connecting shaft AN includes two sections in this case, wherein a first section is associated with the interface IF and a second section is associated with the separating clutch K0. The two sections are connected to each other by the torsional vibration damper TS.

The transmission G is designed, in particular, for use in a motor vehicle, the drive train of which is aligned transversely to the direction of travel of the motor vehicle. For this purpose, the output shaft GW2 includes a tooth system at an interface GW2-A. This tooth system intermeshes with a tooth system of a shaft GW22 aligned axially parallel to the output shaft GW2. Formed on the axially parallel shaft GW22 is yet another tooth system which intermeshes with a tooth system which is formed on a differential gear AG. By way of the differential gear AG, the power present at the output shaft GW2 can be distributed via side shafts DS to wheels (not represented) of the motor vehicle. Every side shaft DS includes two joints GL, wherein the joints GL associated with the differential gear AG are schematically represented in FIG. 1. One of the joints GL is arranged in an area X which abuts the differential gear AG and is arranged radially outside the electric machine EM. The transmission G and the side shaft DS, the joint GL of which is arranged in the area X, form an assembly according to example aspects of the invention.

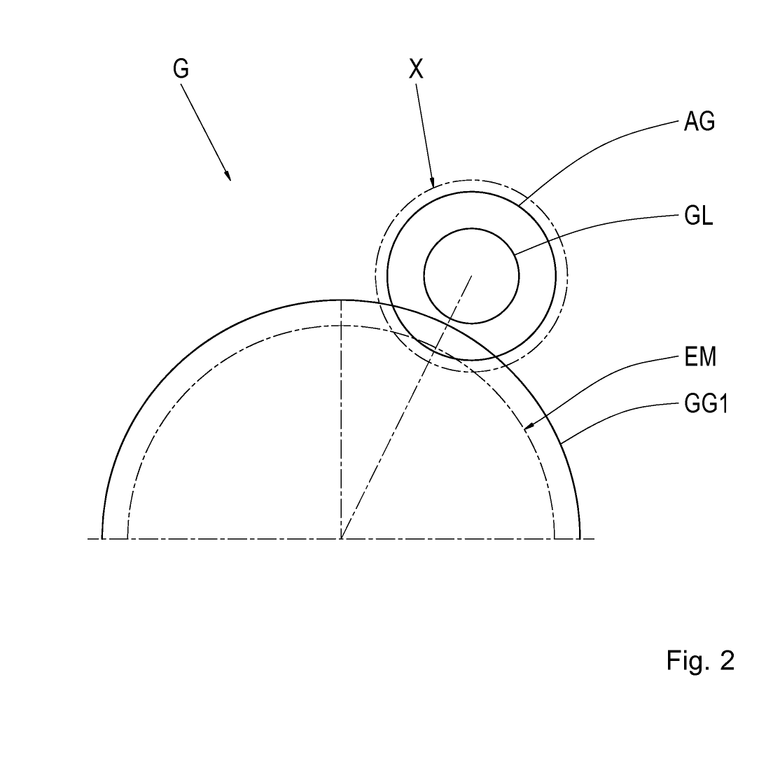

FIG. 2 shows a schematic cutaway view of the transmission G, wherein the selected cutting plane is normal to the input shaft axis. Therein, it is apparent that the side shaft joint GL is arranged centrally with respect to the differential gear AG, wherein only a small air gap is formed between the outer diameter of the side shaft joint GL and a section GG1 of the transmission housing GG. The electric machine EM is arranged on the inside of this transmission housing section GG1.

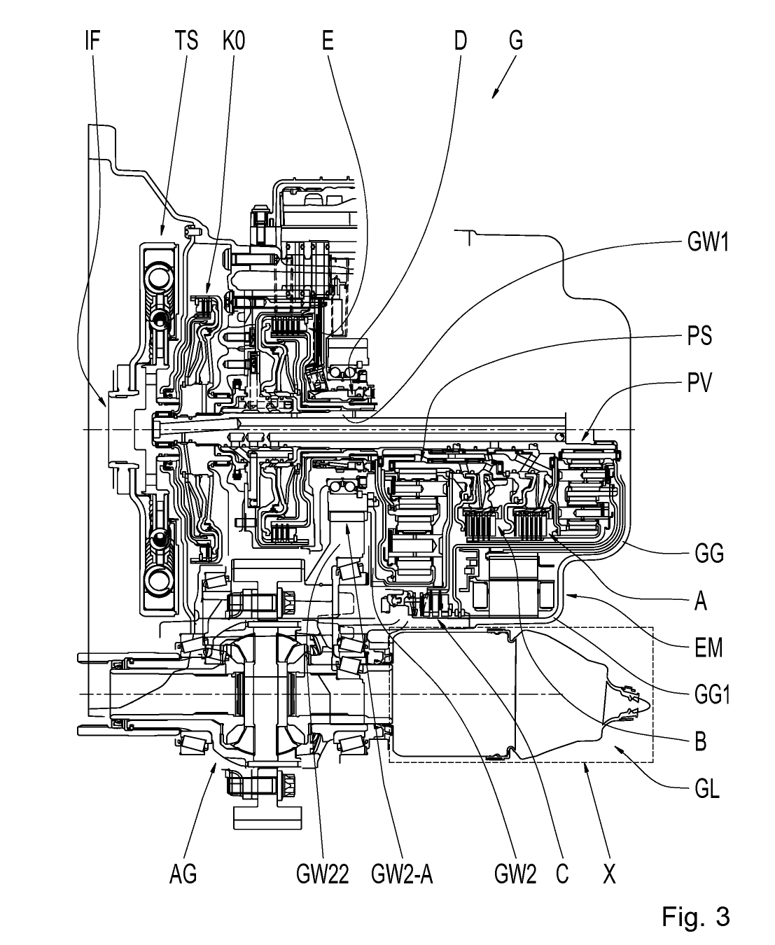

FIG. 3 shows a cutaway view of a structural embodiment of the transmission G. For the sake of greater clarity, parts of the transmission G are hidden in FIG. 3, for example, the power path between the output shaft GW2 and the differential gear AG, and the upper section half of the planetary gear sets PS, PV and of the shift elements A, B, C. The cutting plane was selected in such a way that the arrangement of the side shaft joint GL close to the transmission housing section GG1 is apparent. In FIG. 2, it is clearly apparent that the area X for accommodating the side shaft joint GL directly abuts the differential gear AG and is arranged radially outside the electric machine EM. The transmission G and the side shaft DS, the joint GL of which is arranged in the area X, form an assembly according to example aspects of the invention.

Modifications and variations can be made to the embodiments illustrated or described herein without departing from the scope and spirit of the invention as set forth in the appended claims.

### REFERENCE CHARACTERS

G transmission
GG transmission housing
GG1 transmission housing section
GW1 input shaft
GW2 output shaft
GW2-A interface of the output shaft
GW22 axially parallel shaft
AG differential gear
IF interface
EM electric machine
S stator
R rotor
A shift element
B shift element
C shift element
D shift element
E shift element
PS planetary gear set
PV planetary gear set
X area
DS side shaft
GL joint
AN connecting shaft

1-6: (canceled)

7. A transmission (G) for a motor vehicle, comprising:
an input shaft (GW1);
an output shaft (GW2);
a differential gear (AG);
an interface (IF) to a transmission-external drive unit;
an electric machine (EM) with a rotationally fixed stator (S) and a rotary rotor (R);
a plurality of planetary gear sets (PS, PV); and
a plurality of shift elements (A, B, C, D, E),
wherein, via the planetary gear sets (PS, PV), various gears ratios between the input shaft (GW1) and the output shaft (GW2) are implementable by selectively engaging the shift elements (A, B, C, D, E),
wherein the output shaft (GW2) is permanently operatively connected to at least one element of one of the planetary gear sets (PS, PV), the output shaft (GW2) comprises a tooth system at an interface (GW2-A) that intermeshes with a tooth system of a shaft (GW22), and the shaft (GW22) is axially parallel to the output shaft (GW2),
wherein the shaft (GW 22) is permanently operatively connected to an element of the differential gear (AG),
the rotor (R) is connected to an element of the planetary gear sets (PS, PV) or to the input shaft (GW1) such that the electric machine (EM) is configured for outputting power to the output shaft (GW2) in one or more of the various gear ratios,
wherein the electric machine (EM) is arranged at an axial end of the transmission (G) which is positioned opposite the interface (IF) to the transmission-external drive unit,
wherein the interface (GW2-A) of the output shaft (GW2) is arranged axially between the interface (IF) to the transmission-external drive unit and the electric machine (EM), and
wherein an area (X) directly adjacent the differential gear (AG) is configured for accommodating a side shaft joint (GL), and the area (X) is arranged completely or at least in part in an installation space radially outside the electric machine (EM).

8. The transmission (G) of claim 7, wherein the area (X) for accommodating the side shaft joint (GL) directly abuts an outer wall of a transmission housing section (GG1) while forming an air gap between the side shaft joint (GL) and the outer wall of the transmission housing section (GG1), and the electric machine (EM) is arranged inside of the outer wall of the transmission housing section (GG1).

9. The transmission (G) of claim 7, wherein the planetary gear sets (PS, PV) are arranged axially between the interface (GW2-A) of the output shaft (GW) and the axial end of the transmission (G) at which the electric machine (EM) is arranged.

10. The transmission (G) of claim 9, wherein at least one of the shift elements (A, B, C, D, E) is a friction-locking brake, the friction-locking brake is arranged axially between the interface (GW2-A) of the output shaft (GW) and the electric machine (EM), and the friction-locking brake is arranged radially outside the planetary gear sets (PS, PV).

11. An assembly comprising the transmission (G) of claim 7 and a side shaft (DS) connected to the differential gear (AG) of the transmission (G), the differential gear (AG) configured for transmitting torque between an element of the differential gear (AG) and a driving wheel of a motor vehicle through the side shaft (DS),
wherein the side shaft joint (GL) of the side shaft (DS) is arranged completely or at least in part radially outside the electric machine (EM) of the transmission (G).

12. The assembly of claim 11, wherein the side shaft joint (GL) of the side shaft (DS) directly abuts the outer wall of a transmission housing section (GG1) while forming an air gap between the side shaft joint (GL) and the outer wall of the transmission housing section (GG1), and the electric machine (EM) of the transmission (G) is arranged inside of the outer wall of the transmission housing section (GG1).
